(19) United States
(12) Patent Application Publication
(10) Pub. No.: US 2024/0088522 A1
(43) Pub. Date: Mar. 14, 2024

(54) Bipolar Battery

(71) Applicants: Furukawa Electric Co., Ltd., Tokyo (JP); The Furukawa Battery Co., Ltd., Yokohama (JP)

(72) Inventors: Kenichi Suyama, Tokyo (JP); Hiroki Tanaka, Tokyo (JP); Yasuo Nakajima, Tokyo (JP); Akira Tanaka, Tokyo (JP)

(21) Appl. No.: 18/332,513

(22) Filed: Jun. 9, 2023

Related U.S. Application Data
(63) Continuation of application No. PCT/JP2021/042501, filed on Nov. 18, 2021.

(30) Foreign Application Priority Data
Dec. 10, 2020 (JP) 2020-204822
Dec. 10, 2020 (JP) 2020-204823

(51) Int. Cl. H01M 50/46; H01M 4/14; H01M 10/12; H01M 50/414

(52) U.S. Cl. CPC H01M 50/461; H01M 4/14; H01M 10/12; H01M 50/414; H01M 2004/029

(57) ABSTRACT

A bipolar battery is provided with improved productivity and reliability of bonding between a positive electrode and a substrate (bipolar plate) or a negative electrode and the substrate. The bipolar battery includes a bipolar electrode including a positive electrode, a negative electrode, and a substrate having a first surface on which the positive electrode is provided and a second surface on which the negative electrode is provided. A first adhesion layer is provided between the bipolar plate and the positive electrode and/or between the bipolar plate and the negative electrode. A second adhesion layer is provided at the outer periphery of the first adhesion layer of the positive electrode and/or the negative electrode on which the first adhesion layer is provided. The bipolar plate is formed from resin, the first adhesion layer is formed from an adhesion sheet, and the second adhesion layer is formed from an adhesive cured product.

### CROSS-REFERENCE TO RELATED APPLICATION(S)

This application is a continuation of PCT Application No. PCT/JP2021/042501, filed Nov. 18, 2021, the disclosure of which is incorporated herein in its entirety by reference.

### TECHNICAL FIELD

The present invention relates to a bipolar battery.

### BACKGROUND

A bipolar lead acid battery includes a bipolar electrode including a positive electrode, a negative electrode, and a substrate (bipolar plate) having a first surface on which the positive electrode is provided and a second surface on which the negative electrode is provided. In a conventional bipolar electrode, for example, as in Japanese Patent No. 6124894, because lead layers are provided on both surfaces of a resin substrate, a positive electrode and a negative electrode are provided on the first surface and the second surface of the substrate, respectively.

### SUMMARY

In the bipolar lead acid battery described in Japanese Patent No. 6124894, the lead layers (lead foil) are provided on the substrate by insert molding or plating.

However, by insert molding, only an anchoring effect can be expected for the bonding between the lead layer and the substrate, and reliability for an electrolyte containing sulfuric acid as the main component is low.

By plating, the manufacturing speed is slow, resulting in poor productivity.

Therefore, the present invention has been made with a focus on the above-described problems, and an object of the present invention is to provide a bipolar battery that can improve productivity and reliability of the bonding between a positive electrode and a substrate (bipolar plate) and/or a negative electrode and a substrate.

(1) According to an embodiment of the present invention, a bipolar battery includes a bipolar electrode including a positive electrode, a negative electrode, and a bipolar plate having a first surface on which the positive electrode is provided and a second surface on which the negative electrode is provided. The bipolar battery includes a first adhesion layer provided at least between the bipolar plate and the positive electrode, and between the bipolar plate and the negative electrode. A second adhesion layer is provided at an outer periphery of the first adhesion layer of at least one of the positive electrode or the negative electrode on which the first adhesion layer is provided. The bipolar plate is formed from resin, the first adhesion layer is formed from an adhesion sheet, and the second adhesion layer is formed from an adhesive cured product.

(2) In the configuration (1) described above, the second adhesion layer may be formed at least one of between the bipolar plate and the positive electrode, or between the bipolar plate and the negative electrode.

In the configuration (2) described above, the substrate and the positive electrode or negative electrode made from a lead foil or the like and forming a lead layer may be bonded by the adhesion layer including the adhesive cured product and the adhesion sheet. With this configuration, the substrate and the positive electrode or the negative electrode are bonded by the anchoring effect or chemical bonding, leading to improvement in reliability of the bipolar battery.

In the bipolar battery with the configuration (2) described above, the outer periphery of the adhesion layer may be formed from the adhesive cured product and the inside of the outer periphery may be formed from the adhesion sheet. This allows sufficient sulfuric acid resistance to be ensured in the outer periphery of the adhesion layer where there is a possibility that the electrolyte may intrude from the outer peripheral side of the lead foil of the positive electrode and the negative electrode, or the like. By providing the adhesion sheet on the inside where less sulfuric acid resistance is needed than on the outer periphery, it is possible to prevent the adhesive from flowing into the conduction hole. This can prevent contamination in the portion where the positive electrode and the negative electrode are conducting. Note that this effect can prevent contamination of the lead foil or the like and a conductor in a similar manner to the case of inserting the conductor into the conduction hole as means for conduction between the positive electrode and the negative electrode.

Furthermore, the bipolar battery with the configuration (1) described above can increase the manufacturing speed and improve productivity more than by the method for plating the substrate to provide electrodes. The method for plating the substrate to provide electrodes needs conductivity in the substrate, but the bipolar battery according to the present embodiment does not need conductivity in the substrate. Therefore, the type of materials that can be selected for the substrate increases, and materials that are better in cost, reliability, and the like can be selected.

(3) In the configuration (2) described above, the outer periphery of the adhesion layer formed from the adhesive cured product may be formed with a width of 1.0 mm or more from a peripheral edge of the positive electrode and/or the negative electrode (i.e., at least one of the positive electrode or the negative electrode) on which the adhesion layer is provided.

The configuration (3) described above can prevent liquid junction between the positive electrode and the negative electrode, and a battery with excellent long-term reliability can result.

(4) In the configuration (3) described above, the substrate may include a plurality of conduction holes, and the outer periphery of the adhesion layer formed from the adhesive cured product may be formed up to a position 20 mm or more away from the conduction hole closest to the peripheral edge.

The configuration (4) described above can prevent the adhesive from flowing into the conduction holes and can construct a battery with excellent reliability.

(5) In the configuration (1) described above, the second adhesion layer may be provided at a peripheral edge of at least one of the positive electrode or the negative electrode on which the first adhesion layer is provided.

The configuration (5) described above can prevent the electrolyte from intruding from the outer peripheral side of the positive electrode and the negative electrode with the second adhesion layer and secure sufficient sulfuric acid resistance. Therefore, liquid junction between the positive electrode and the negative electrode caused by intrusion of sulfuric acid does not occur, and a battery having excellent long-term reliability can be constructed. The first adhesion layer can prevent contamination in the portion where the positive electrode and the negative electrode are conducting.

(6) In the configuration (5) described above, the second adhesion layer may be further formed at a peripheral portion on at least one of a substrate side or a side opposite to the substrate of at least one of the positive electrode or the negative electrode on which the first adhesion layer is provided.

The configuration (6) described above can prevent the electrolyte from intruding between the substrate and the positive electrode or the negative electrode more than the configuration (1) described above, and therefore can further improve battery reliability.

(7) In any one of the configurations (1) to (6) described above, the bipolar battery may be a bipolar lead acid battery.

### BRIEF DESCRIPTION OF THE DRAWINGS

FIG. 1 is a cross-sectional view illustrating a bipolar lead acid battery according to a first embodiment of the present invention.

FIG. 2 is a plan view illustrating a substrate (bipolar plate) of the bipolar lead acid battery according to the first embodiment.

FIG. 3 is an enlarged cross-sectional view illustrating a bipolar electrode of the bipolar lead acid battery according to the first embodiment.

FIG. 4A and FIG. 4B are explanatory view illustrating a method for bringing a positive electrode and a negative electrode into conduction. FIG. 4A is an enlarged cross-sectional view illustrating a state before a positive electrode lead layer and a negative electrode lead layer are pressure-bonded. FIG. 4B is an enlarged cross-sectional view illustrating a state after the positive electrode lead layer and the negative electrode lead layer are pressure-bonded.

FIG. 5 is a plan view illustrating an adhesion layer of the bipolar lead acid battery.

FIG. 6 is an enlarged cross-sectional view illustrating a bipolar electrode of a bipolar lead acid battery according to a second embodiment.

FIG. 7 is an enlarged cross-sectional view illustrating a bipolar electrode of a bipolar lead acid battery according to a third embodiment.

FIG. 8 is an enlarged cross-sectional view illustrating a bipolar electrode of a bipolar lead acid battery according to a fourth embodiment.

FIG. 9 is an enlarged cross-sectional view illustrating a bipolar electrode of a bipolar lead acid battery according to a fifth embodiment.

### DETAILED DESCRIPTION

Embodiments of the present invention will be described. Note that the embodiments described below are examples of the present invention. Various changes or improvements can be added to the embodiments, and modes to which such changes or improvements are added can also be included in the present invention.

### First Embodiment

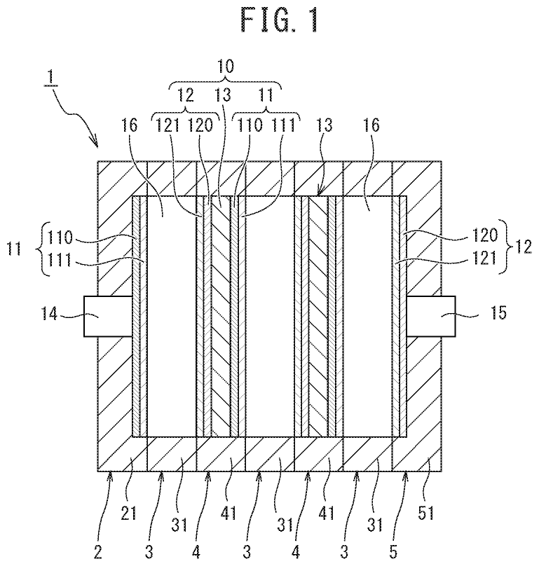

A structure of a bipolar lead acid battery 1, which is a bipolar battery according to a first embodiment of the present invention, will be described with reference to FIGS. 1 to 5. The bipolar lead acid battery 1 illustrated in FIG. 1 includes a first plate unit 2 in which a negative electrode 11 is fixed to a flat plate-shaped first plate 21 (also called an end plate), a second plate unit 3 in which an electrolytic layer 16 is fixed to the inside of a frame plate-shaped second plate 31 (also called a spacer), a third plate unit 4 in which a bipolar electrode 10 including a positive electrode 12, the negative electrode 11, and a substrate 13 (also called a bipolar plate) having a first surface on which the positive electrode 12 is provided and a second surface on which the negative electrode 11 is provided is fixed to inside of a frame plate-shaped third plate 41 (also called a rim), and a fourth plate unit 5 in which the positive electrode 12 is fixed to a flat plate-shaped fourth plate 51 (also called an end plate).

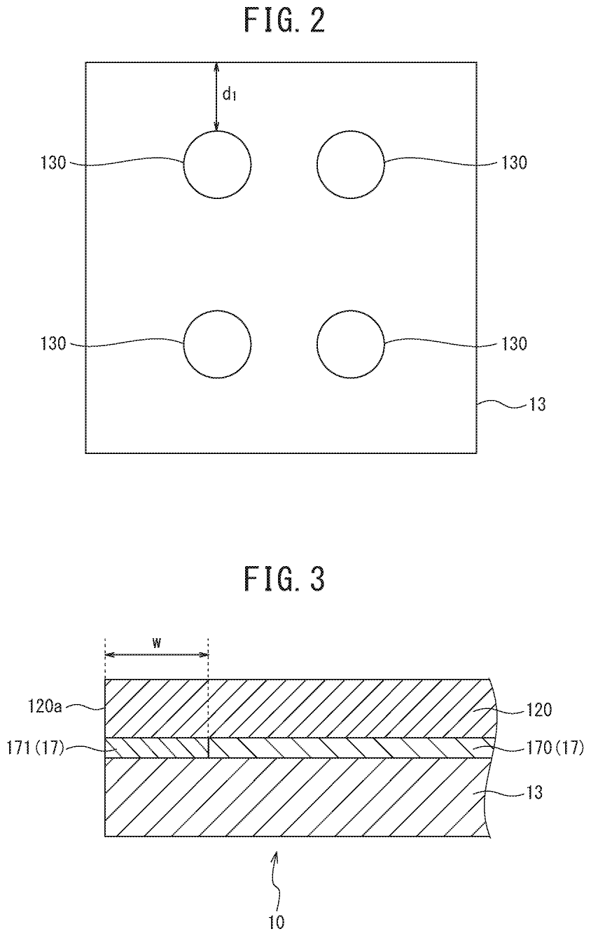

The substrate 13 is formed from resin, preferably formed from thermoplastic resin. The substrate 13 can be made from or include one or more other materials, for example, acid-resistant plastic such as acrylonitrile-butadiene-styrene copolymer (ABS) resin, polypropylene or polyvinyl chloride (PVC), or the like. Such a thermoplastic resin has excellent moldability and excellent sulfuric acid resistance described later. Therefore, even if the electrolyte comes into contact with the substrate 13, the substrate 13 is unlikely to be decomposed, deteriorated, corroded, or the like. In the substrate 13, as illustrated in FIG. 2, a plurality of conduction holes 130 penetrating from one surface to the other surface of the substrate 13 is formed. Although the shape and dimension of the plurality of conduction holes 130 are not particularly limited, the example illustrated in FIG. 2 has a circular shape as one example. The plurality of conduction holes 130 is preferably formed at the position where the distance d₁ to a periphery of the substrate 13 from the conduction hole 130 closest to the periphery is 21 mm or more.

The bipolar lead acid battery 1 having a substantially rectangular parallelepiped shape is constructed by alternately stacking the second plate units 3 and the third plate units 4 between the first plate unit 2 and the fourth plate unit 5. The number of stacked second plate units 3 and the number of stacked third plate units 4 are set such that the storage capacity of the bipolar lead acid battery 1 has a desired value.

A negative terminal 14 is fixed to the first plate 21, and the negative electrode 11 fixed to the first plate 21 and the negative terminal 14 are electrically connected.

A positive terminal 15 is fixed to the fourth plate 51, and the positive electrode 12 fixed to the fourth plate 51 and the positive terminal 15 are electrically connected.

The electrolytic layer 16 includes, for example, a glass fiber mat impregnated with an electrolyte containing sulfuric acid.

The first plate 21, second plate 31, third plate 41, and fourth plate 51 are formed from, for example, a known molding resin. The first plate 21, second plate 31, third plate 41, and fourth plate 51 are fixed to each other by an appropriate method such that the inside is sealed to prevent the electrolyte from flowing out.

The positive electrode 12 includes a positive electrode lead layer 120 that is a lead foil made from lead or a lead alloy and disposed on one surface of the substrate 13, a positive active material layer 121 disposed on the positive electrode lead layer 120, and an adhesion layer 17 disposed between one surface of the substrate 13 and the positive electrode lead layer 120 to bond one surface of the substrate 13 to the positive electrode lead layer 120. That is, the adhesion layer 17, the positive electrode lead layer 120, and the positive active material layer 121 are stacked in this order on one surface of the substrate 13 (surface facing upward in the paper surface in FIG. 3).

The negative electrode 11 includes a negative electrode lead layer 110 that is a lead foil made from lead or a lead alloy and disposed on the other surface of the substrate 13, a negative active material layer 111 disposed on the negative electrode lead layer 110, and the adhesion layer 17 (not illustrated) disposed between the other surface of the substrate 13 and the negative electrode lead layer 110 to bond the other surface of the substrate 13 to the negative electrode lead layer 110. Note that in the following description, the positive electrode lead layer 120 and the negative electrode lead layer 110 are also collectively referred to as lead layers.

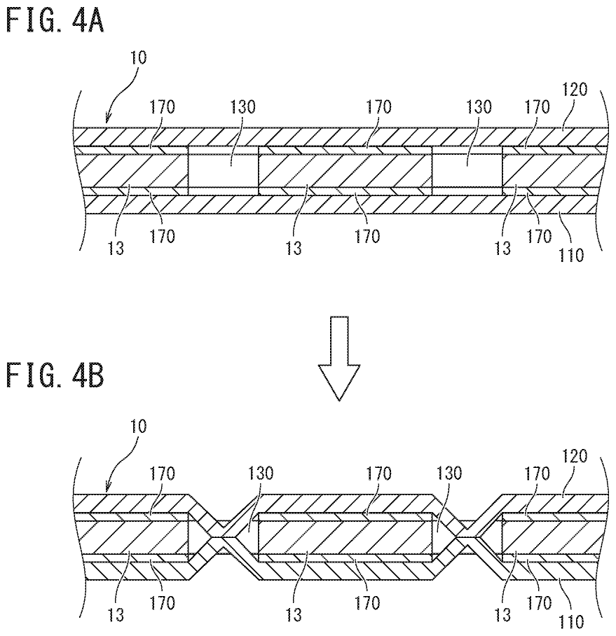

The positive electrode 12 and negative electrode 11 are electrically connected by an appropriate method. In the present embodiment, the positive electrode 12 and the negative electrode 11 are electrically connected through the conduction hole 130 of the substrate 13. For example, as illustrated in FIGS. 4A and 4B, the connection between the positive electrode 12 and the negative electrode 11 is made by pressure bonding the positive electrode lead layer 120 and the negative electrode lead layer 110, that is, the positive electrode lead foil and the negative electrode lead foil in the conduction hole 130. Note that FIG. 4A illustrates the state before pressure bonding between the positive electrode lead layer 120 and the negative electrode lead layer 110, and FIG. 4B illustrates the state after pressure bonding between the positive electrode lead layer 120 and the negative electrode lead layer 110. Note that the method for electrically connecting the positive electrode 12 and the negative electrode 11 is not limited to the above means. As a method for electrically connecting the positive electrode 12 and the negative electrode 11, for example, inserting a conductor made from lead or a lead alloy into the conduction hole 130 and electrically connecting the conductor to the positive electrode lead layer 120 and the negative electrode lead layer 110 may be used.

Note that in the cross-sectional view of the bipolar electrode illustrated in FIG. 3, illustration of the negative electrode 11 and the positive active material layer 121 is omitted. In the cross-sectional view of the bipolar electrode illustrated in FIGS. 4A and 4B, illustration of the negative active material layer 111 and the positive active material layer 121 is omitted.

In the bipolar lead acid battery 1 according to the present embodiment having such a configuration, as described above, the substrate 13, the positive electrode lead layer 120, the positive active material layer 121, the negative electrode lead layer 110, and the negative active material layer 111 constitute the bipolar electrode 10. The bipolar electrode is a single electrode that functions as both the positive electrode and the negative electrode.

The bipolar lead acid battery 1 according to the present embodiment has a battery configuration in which cell members are connected in series by alternately stacking and assembling the plurality of cell members in which the electrolytic layer 16 is interposed between the positive electrode 12 and the negative electrode 11.

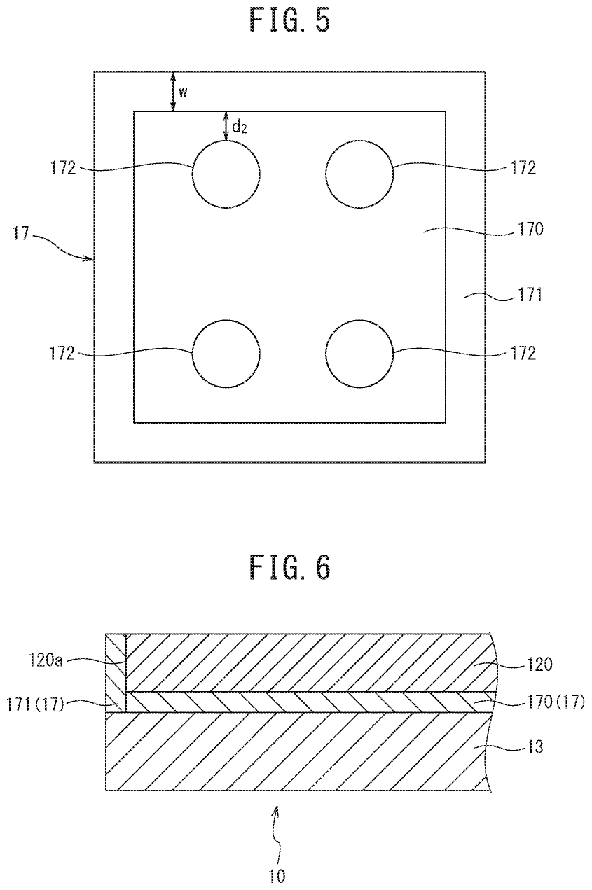

Furthermore, in the bipolar lead acid battery 1 according to the present embodiment, the outer periphery of the adhesion layer 17 is formed as a second adhesion layer 171, and the inside of the outer periphery is formed as a first adhesion layer 170, as illustrated in FIGS. 3 and 5. Note that the second adhesion layer 171 and the first adhesion layer 170 are preferably formed continuously, with no gap therebetween.

The second adhesion layer 171 is formed from an adhesive cured product. The adhesive cured product is a cured product of a reaction-curing adhesive in which a main agent and a curing agent react to cure. The adhesive cured product is preferably resistant to sulfuric acid (hereinafter, the property of being resistant to sulfuric acid is sometimes referred to as “sulfuric acid resistance”). For example, an epoxy-based adhesive can be applied. The epoxy-based adhesive includes an epoxy resin as a main agent and an acid or basic curing agent as a curing agent. Such a reaction-curing adhesive, which can be cured at room temperature (for example, between 20° C. and 40° C., inclusive), can be cured at a temperature that does not easily affect the metal structure of lead or lead alloy forming the positive electrode lead layer 120 and the negative electrode lead layer 110. Furthermore, the above-described reaction-curing adhesive hardly exerts an adverse effect on the thermoplastic resin that forms the substrate 13. Furthermore, the above-described reaction-curing adhesive has advantages such as high adhesiveness and long usable life. The compounding ratio of the main agent and the curing agent in the reaction-curing adhesive is preferably 44 parts per 100 parts of the main agent or less of the curing agent by mass.

Examples of the main agent of the epoxy-based adhesive include, but are not limited to, bisphenol A type epoxy resin and bisphenol F type epoxy resin.

Examples of the acid curing agent of the epoxy-based adhesive include aromatic anhydrides, cycloaliphatic anhydrides, and aliphatic anhydrides. One type of these acid anhydrides may be used separately, or two or more types may be used in combination. Specific examples of aromatic anhydride include pyromellitic anhydride, 3,3′,4,4′-benzophenonetetracarboxylic dianhydride, 4,4′-biphthalic anhydride, 3,3′,4,4′-diphenylsulfonetetracarboxylic dianhydride, 9,9-bis (3,4-dicarboxyphenyl) fluorene dianhydride, 4,4′-(4,4′-isopropylidenediphenol) diphthalic anhydride, naphthalene-1,4,5,8-tetracarboxylic dianhydride, 2,3,6,7-naphthalenetetracarboxylic acid 2,3:6,7-dianhydride, 4,4′-oxydiphthalic anhydride, 3,4,9,10-perylenetetracarboxylic dianhydride, bis (1,3-dioxo-1,3-dihydroisobenzofuran-5-carboxylic acid) 1,4-phenylene, and 4,4′-(hexafluoroisopropylidene) diphthalic anhydride. Specific examples of cycloaliphatic anhydrides include methyltetrahydrophthalic anhydride, tetrahydrophthalic anhydride, methylnadic anhydride, hexahydrophthalic anhydride, and methylhexahydrophthalic anhydride. Aliphatic anhydrides include polycarboxylic anhydrides obtained by intermolecular dehydration condensation reaction of aliphatic dibasic acid.

Examples of basic curing agents of the epoxy-based adhesive include aliphatic polyamine compounds, alicyclic polyamine compounds, and aromatic polyamine compounds. One type of these amine compounds may be used separately, or two or more types may be used in combination.

Specific examples of aliphatic polyamine compounds include aliphatic primary amines such as triethylenetetramine (C₆H₁₈N₄), and aliphatic secondary amines such as triethylenetetramine. Specific examples of cycloaliphatic polyamine compounds include cycloaliphatic primary amines such as isophoronediamine (C₁₀H₂₂N₂). Specific examples of aromatic polyamine compounds include aromatic primary amines such as diaminodiphenylmethane (C₁₃H₁₄N₂).

The second adhesion layer 171, which is the outer periphery of the adhesion layer 17 formed from the adhesive cured product, is formed with a predetermined width w from the peripheral edge 110a and peripheral edge 120a of the negative electrode lead layer 110 and the positive electrode lead layer 120 respectively (peripheral edge 110a of negative electrode lead layer 110 is not illustrated). The width w is the length extending inward from the peripheral edge and is preferably 1.0 mm or more.

Here, the inventors verified the sulfuric acid resistance of the adhesive cured product. In the verification, 20 parts per hundred rubber (phr) of an aliphatic polyamine curing agent was added to the bisphenol A type epoxy main agent, was cast into a plate shape with a thickness of 2 mm at a room temperature in the air, and was cured at 70° C. for one hour. After that, a specimen was cut into a predetermined length and used as a test piece.

The test environment was a sulfuric acid aqueous solution at 75° C. and 38 mass %, and the test piece was simply immersed in the solution for up to about 2000 hours. After a predetermined time passed, the test piece was removed from the sulfuric acid aqueous solution, and observation and measurement of an S atom, that is, sulfuric acid intrusion depth, were performed with a microscopy and energy dispersive X-ray spectroscopy (EDS) about the cross section of the test piece with the solution wiped off in an environment with a 20° C. room temperature.

From measurement results of immersion time of the test piece and the sulfuric acid intrusion distance, it was confirmed that conduction (liquid junction) between the positive electrode and the negative electrode caused by the intrusion of sulfuric acid did not occur and that a battery with excellent long-term reliability can be constructed if there is an adhesive cured product layer with a width w of 1.0 mm or more. More preferably, the width w is set to 1.5 mm or more, and such a structure makes it possible to prevent the occurrence of liquid junction over a long period of about 15 years.

Furthermore, the second adhesion layer 171, which is the outer periphery of the adhesion layer 17 formed from an adhesive cured product, is preferably formed up to the position 20 mm or more away from the conduction hole 130 closest to the peripheral edge of the lead layer of the positive electrode 12 or the negative electrode 11. That is, in the second adhesion layer 171, which is the outer periphery of the adhesion layer 17 formed from an adhesive cured product, the distance d₂ that is the distance from the conduction hole 130 closest to the peripheral edge of the lead layer of the positive electrode 12 or the negative electrode 11 to the outer periphery is preferably 20 mm or more, as illustrated in FIG. 5. Such a configuration can prevent the adhesive that will form the second adhesion layer 171 from flowing into the conduction hole 130.

The first adhesion layer 170 is formed from an adhesion sheet. The adhesion sheet is an adhesive or sticky film-like member and has a plurality of holes 172 of the same shape as the conduction holes 130 at locations corresponding to the plurality of conduction holes 130 on the substrate 13. The adhesion sheet that forms the first adhesion layer 170 may or may not have a substrate as a support. Note that the adhesion sheet with a substrate is more preferable to the adhesion sheet without a substrate because workability, especially punching workability, improves.

The adhesion sheet having a substrate has a pressure sensitive adhesive layer or adhesive layer provided on both surfaces of the film-like substrate. The substrate is a nonwoven fabric, a film, or the like, and examples thereof include, but are not limited to, polyester, polyolefin, polyimide film, and fluorine (Teflon®) film. As the pressure sensitive adhesive layer, a rubber-based, acrylic-based, or silicone-based pressure sensitive adhesive can be used. As the adhesive layer, a B-staged (semi-cured) rubber-based, acrylic-based, epoxy-based, or silicone-based adhesive can be used. In particular, the epoxy-based adhesive is expected to improve reliability because of superior electrolyte (sulfuric acid) resistance. When the pressure sensitive adhesive is used, no heating is needed when attaching the lead foil. When the adhesive is used, heating is needed when attaching the lead foil that forms the lead layer, and there is a concern about thermal effects on the lead foil.

Meanwhile, as the adhesion sheet having no substrate, the above-described pressure sensitive adhesive or adhesive is used. As described above, from the viewpoint of workability, the adhesion sheet preferably has a substrate, but the present invention can also be applied to an adhesion sheet having no substrate.

Note that in the present embodiment, the adhesion layer 17 is provided on both surfaces on the positive electrode side and the negative electrode side of the substrate 13, but the present invention is not limited to such an example. The adhesion layer 17 is required to be provided on at least one of the positive electrode side or the negative electrode side of the substrate 13. If the adhesion layer 17 is not provided on one surface of the substrate 13, the lead layer may be provided on one surface of the substrate 13 by another known method.

(11) The bipolar lead acid battery 1 according to the first embodiment of the present invention is the bipolar lead acid battery 1 including the bipolar electrode 10 including the positive electrode 12, the negative electrode 11, and the substrate 13 (bipolar plate) having a first surface on which the positive electrode 12 is provided and a second surface on which the negative electrode 11 is provided. The bipolar lead acid battery 1 includes the adhesion layer 17 provided at least one of between the substrate 13 and the positive electrode 12 or between the substrate 13 and the negative electrode 11. The substrate 13 is formed from resin. In the adhesion layer 17, the outer periphery is formed from the second adhesion layer 171 formed from an adhesive cured product, and the inside of the outer periphery is formed from the first adhesion layer 170 formed from the adhesion sheet.

In the configuration (11) described above, the substrate 13 and the lead foil serving as the lead layer of the positive electrode 12 or the negative electrode 11 are bonded by the adhesion layer 17 including the first adhesion layer 170 and the second adhesion layer 171. With this configuration, the substrate 13 and the lead foil of the positive electrode 12 or the negative electrode 11 are bonded by the anchoring effect or chemical bonding, leading to improvement in reliability of the bipolar lead acid battery 1.

The outer periphery of the adhesion layer 17 is formed from the second adhesion layer 171, and the inside of the outer periphery is formed from the first adhesion layer 170. This allows sufficient sulfuric acid resistance to be ensured in the outer periphery of the adhesion layer 17 where there is a possibility that the electrolyte may intrude from the outer peripheral side of the lead foil of the positive electrode 12 or the negative electrode 11. By providing the first adhesion layer 170 on the inside where less sulfuric acid resistance is needed than on the outer periphery, it is possible to prevent the adhesive from flowing into the conduction hole 130. This makes it possible to prevent contamination in a portion where the positive electrode 12 and the negative electrode 11 are conducting, for example, in a portion where the lead foils are bonded by pressure in FIGS. 4A and 4B. Note that this effect makes it possible to prevent contamination of the lead foil and a conductor in a similar manner to the case of inserting the conductor into the conduction hole 130 as means for conduction between the positive electrode 12 and the negative electrode 11.

Furthermore, the bipolar lead acid battery 1 according to the first embodiment can increase the manufacturing speed and improve productivity more than by the method for plating the substrate to provide electrodes. The method for plating the substrate to provide electrodes needs conductivity in the substrate, but the bipolar lead acid battery 1 according to the present embodiment does not need conductivity in the substrate 13. Therefore, the type of materials that can be selected for the substrate 13 increases, and materials that are better in cost, reliability, and the like can be selected.

(12) In the configuration (11) described above, the outer periphery of the adhesion layer 17 formed from the second adhesion layer 171 has a width w of 1.0 mm or more from the peripheral edge 110a and peripheral edge 120a of the lead layer of at least one of the positive electrode 12 or the negative electrode 11 (positive electrode lead layer 120, negative electrode lead layer 110) on which the first adhesion layer 170 is provided.

The configuration (12) described above can prevent liquid junction between the positive electrode 12 and the negative electrode 11 and can construct a battery with excellent long-term reliability.

(13) In the configuration (12) described above, the substrate 13 includes the plurality of conduction holes 130, and the outer periphery of the adhesion layer 17 formed from the second adhesion layer 171 is formed up to a position 20 mm or more away from the conduction hole 130 closest to the peripheral edge 110a and peripheral edge 120a.

The configuration (13) described above can prevent the adhesive from flowing into the conduction holes 130 and can construct a battery with excellent reliability.

### Second Embodiment

A bipolar lead acid battery 1 that is a bipolar battery according to a second embodiment of the present invention will be described. Although the bipolar battery according to the second embodiment differs from the first embodiment in the configuration of an adhesion layer 17, other configurations, for example, the configurations illustrated in FIGS. 1, 2, 4A, and 4B are the same as in the first embodiment. Therefore, in the following description, descriptions of the same configuration as in the first embodiment will be omitted.

In the second embodiment, as illustrated in FIG. 6, a positive electrode 12 includes a positive electrode lead layer 120 that is a lead foil made from lead or a lead alloy and disposed on one surface of a substrate 13, a positive active material layer 121 disposed on the positive electrode lead layer 120, a first adhesion layer 170 disposed between one surface of the substrate 13 and the positive electrode lead layer 120 to bond one surface of the substrate 13 to the positive electrode lead layer 120, and a second adhesion layer 171 formed at least at a peripheral edge 120a of the positive electrode lead layer 120. The first adhesion layer 170 and the second adhesion layer 171 are collectively referred to as an adhesion layer 17. That is, the first adhesion layer 170 (adhesion layer 17), the positive electrode lead layer 120, and the positive active material layer 121 are stacked in this order on one surface of the substrate 13 (surface facing upward in the paper surface in FIG. 6).

A negative electrode 11 includes a negative electrode lead layer 110 that is a lead foil made from lead or a lead alloy and disposed on the other surface of the substrate 13, a negative active material layer 111 disposed on the negative electrode lead layer 110, the first adhesion layer 170 (not illustrated) disposed between the other surface of the substrate 13 and the negative electrode lead layer 110 to bond the other surface of the substrate 13 to the negative electrode lead layer 110, and the second adhesion layer 171 (not illustrated) formed at least at a peripheral edge 110a of the negative electrode lead layer 110. Note that in the following description, the positive electrode lead layer 120 and the negative electrode lead layer 110 are also collectively referred to as lead layers. Note that in the cross-sectional view of the bipolar electrode illustrated in FIGS. 6 to 9, illustration of the negative electrode 11 and the positive active material layer 121 is omitted.

Furthermore, in the bipolar lead acid battery 1 according to the second embodiment, the first adhesion layer 170 is formed from an adhesion sheet having the same shape as the positive electrode lead layer 120 or the negative electrode lead layer 110 and a plurality of holes with the same shape as conduction holes 130. The adhesion sheet may or may not have a substrate as a support. Note that the adhesion sheet with a substrate is more preferable to the adhesion sheet without a substrate because workability, especially punching workability, improves.

The adhesion sheet having a substrate has a pressure sensitive adhesive layer or adhesive layer provided on both surfaces of the film-like substrate. The substrate is a nonwoven fabric, a film, or the like, and examples thereof include, but are not limited to, polyester, polyolefin, polyimide film, and fluorine (Teflon®) film. As the pressure sensitive adhesive layer, a rubber-based, acrylic-based, or silicone-based pressure sensitive adhesive, or some combination thereof, can be used. As the adhesive layer, a B-staged (semi-cured) rubber-based, acrylic-based, epoxy-based, or silicone-based adhesive can be used. In particular, the epoxy-based adhesive is expected to improve reliability because of superior electrolyte (sulfuric acid) resistance. When the pressure sensitive adhesive is used, no heating is needed when attaching the lead foil. When the adhesive is used, heating is needed when attaching the lead foil that forms the lead layer, and there is a concern about thermal effects on the lead foil.

Meanwhile, as the adhesion sheet having no substrate, the above-described pressure sensitive adhesive or adhesive is used. As described above, from the viewpoint of workability, the adhesion sheet preferably has a substrate, but the present invention can also be applied to an adhesion sheet having no substrate.

The second adhesion layer 171 is provided at least at the peripheral edge 110a and peripheral edge 120a of the lead layer and formed from an adhesive cured product. The adhesive cured product is the same as in the first embodiment. In the second embodiment, as illustrated in FIG. 6, the second adhesion layer 171 is formed in contact with the end face of the peripheral edge 120a and the first adhesion layer 170 (left-side end face in FIG. 6) on the peripheral edge 120a side of the positive electrode lead layer 120, which is a lead layer. The second adhesion layer 171 is formed to have a height from one surface of the substrate 13 to a surface on a side opposite to the substrate of the positive electrode lead layer 120, which is the opposite side of the substrate 13, in the thickness direction of the substrate 13 (up-and-down direction in FIG. 6).

In the bipolar lead acid battery 1 according to the second embodiment, the second adhesion layer 171 made from an adhesive cured product is provided on the peripheral edge side of the lead foil of the positive electrode 12 or the negative electrode 11. This configuration makes it possible to prevent an electrolyte from intruding from the outer peripheral side of the lead foil of the positive electrode 12 or the negative electrode 11, and to ensure sufficient sulfuric acid resistance. This makes it possible to construct a battery that is excellent in long-term reliability without occurrence of conduction (liquid junction) between the positive electrode and the negative electrode caused by intrusion of sulfuric acid.

The first adhesion layer 170 made from an adhesion sheet is provided in a portion of the substrate 13 where the conduction holes 130 are provided. This makes it possible to prevent the adhesive that forms the adhesive cured product of the second adhesion layer 171 from flowing into the conduction hole 130 and to prevent contamination in a portion where the positive electrode 12 and the negative electrode 11 are conducting, for example, in a portion where the lead foils are bonded by pressure in FIGS. 4A and 4B. Note that this effect makes it possible to prevent contamination of the lead foil and a conductor in a similar manner to the case of inserting the conductor into the conduction hole 130 as means for conduction between the positive electrode 12 and the negative electrode 11.

Furthermore, the bipolar lead acid battery 1 according to the second embodiment can increase the manufacturing speed and improve productivity more than by the method for plating the substrate to provide electrodes. The method for plating the substrate to provide electrodes needs conductivity in the substrate, but the bipolar lead acid battery 1 according to the present embodiment does not need conductivity in the substrate 13. Therefore, the type of materials that can be selected for the substrate 13 increases, and materials that are better in cost, reliability, and the like can be selected.

### Third Embodiment

A bipolar lead acid battery 1 that is a bipolar battery according to a third embodiment of the present invention differs from the second embodiment in the configuration of a second adhesion layer 171, but other configurations, for example, the configurations illustrated in FIGS. 1, 2, 4A, and 4B are the same as in the second embodiment. Therefore, in the following description, descriptions of the same configuration as in the second embodiment will be omitted.

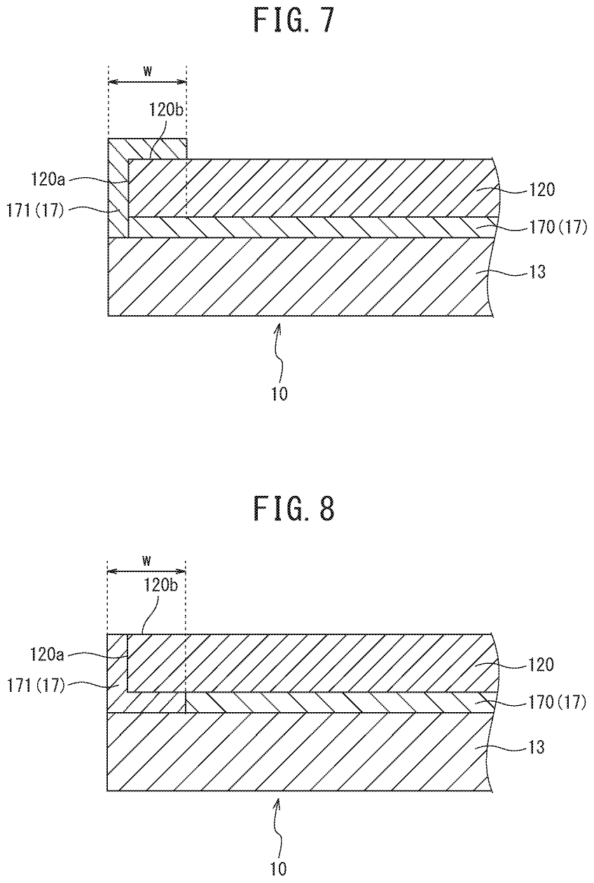

In the third embodiment, as illustrated in FIG. 7, the second adhesion layer 171 is formed not only at a peripheral edge but also on a peripheral portion of a lead layer. Here, the peripheral portion is a peripheral portion 120b (peripheral portion 110b for negative electrode 11) of the outer periphery of a positive electrode lead layer 120 (negative electrode lead layer 110 for negative electrode 11), which is a lead layer, as illustrated in FIG. 7. The second adhesion layer 171 formed on the peripheral portion is formed on a surface of the lead layer on a side opposite to a substrate on which a substrate 13 is provided.

Note that considering the efficiency of the battery, the width w on the outer peripheral portion of the second adhesion layer 171 (length of lead foil inward from the peripheral edge) is preferably small, preferably less than 10 mm, and more preferably less than 4.6 mm.

Other configurations such as the material of the second adhesion layer 171 are the same as in the second embodiment.

In the bipolar lead acid battery 1 according to the third embodiment, the second adhesion layer 171 is also formed on a side opposite to the substrate of the peripheral portion of the lead foil. This makes it possible to prevent the electrolyte from intruding between the substrate 13 and the lead foil more than in the second embodiment, and to improve battery reliability.

### Fourth Embodiment

A bipolar lead acid battery 1 that is a bipolar battery according to a fourth embodiment of the present invention differs from the second embodiment in the configuration of a first adhesion layer 170 and a second adhesion layer 171. However, other configurations, for example, the configurations illustrated in FIGS. 1, 2, 4A, and 4B are the same as in the second embodiment. Therefore, in the following description, descriptions of the same configuration as in the second embodiment will be omitted.

In the fourth embodiment, as illustrated in FIG. 8, the second adhesion layer 171 is formed not only at a peripheral edge but also on a peripheral portion 120b of a lead layer (peripheral portion 110b for negative electrode 11). The second adhesion layer 171 formed on the peripheral portion is formed on a surface on the substrate side of the lead layer. The first adhesion layer 170 has a shape smaller than the lead foil excluding the peripheral portion to the extent that the second adhesion layer 171 is formed in the peripheral portion, as illustrated in FIG. 6.

Note that the width w on the outer peripheral portion of the second adhesion layer 171 is preferably large in consideration of sulfuric acid resistance. However, because it is necessary to prevent an adhesive from flowing into conduction holes 130, formation to a position 20 mm or more away from the conduction hole 130 closest to the peripheral edge is preferable.

Other configurations such as the material of the first adhesion layer 170 and the second adhesion layer 171 are the same as in the second embodiment.

In the bipolar lead acid battery 1 according to the fourth embodiment, the second adhesion layer 171 is also formed on the substrate side of the peripheral portion of the lead foil. This makes it possible to prevent the electrolyte from intruding between the substrate 13 and the lead foil more than in the second embodiment, and to improve battery reliability.

### Fifth Embodiment

A bipolar lead acid battery 1 that is a bipolar battery according to a fifth embodiment of the present invention differs from the second embodiment in the configuration of a first adhesion layer 170 and a second adhesion layer 171, but other configurations, for example, the configurations illustrated in FIGS. 1, 2, 4A, and 4B are the same as in the second embodiment. Therefore, in the following description, descriptions of the same configuration as in the second embodiment will be omitted.

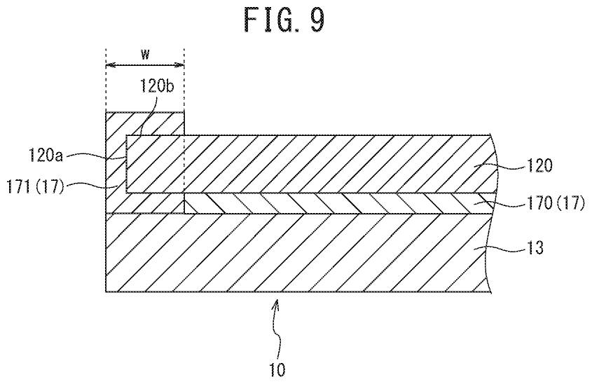

In the fifth embodiment, as illustrated in FIG. 9, the second adhesion layer 171 is formed not only at a peripheral edge but also on a peripheral portion 120b of a lead layer (peripheral portion 110b for negative electrode 11). The second adhesion layer 171 formed on the peripheral portion is formed on both surfaces on the substrate side and the side opposite to the substrate of the lead layer. The first adhesion layer 170 has a shape smaller than the lead foil excluding the peripheral portion to the extent that the second adhesion layer 171 is formed on the peripheral portion, as illustrated in FIG. 9.

Note that the width w of the outer peripheral portion of the second adhesion layer 171 is the same as in the third and fourth embodiments.

Other configurations such as the material of the first adhesion layer 170 and the second adhesion layer 171 are the same as in the second embodiment.

In the bipolar lead acid battery 1 according to the fifth embodiment, the second adhesion layer 171 is also formed on the substrate side and the side opposite to the substrate of the peripheral portion of the lead foil. This makes it possible to prevent the electrolyte from intruding between the substrate 13 and the lead foil more than in the second to fourth embodiments, and to further improve battery reliability.

Note that in the second to fifth embodiments, the first adhesion layer 170 and the second adhesion layer 171 are provided on both surfaces on the positive electrode side and the negative electrode side of the substrate 13, but the present invention is not limited to such an example. The first adhesion layer 170 and the second adhesion layer 171 are required to be provided on at least one of the positive electrode side or the negative electrode side of the substrate 13. If the first adhesion layer 170 and the second adhesion layer 171 are not provided on one surface of the substrate 13, the positive electrode 12 or the negative electrode 11 may be provided on one surface of the substrate 13 by another known method.

(14) The bipolar lead acid battery 1 according to the second to fifth embodiments of the present invention is a bipolar lead acid battery including the bipolar electrode 10 including the positive electrode 12, the negative electrode 11, and the substrate 13 (bipolar plate) having a first surface on which the positive electrode 12 is provided and a second surface on which the negative electrode 11 is provided. The bipolar lead acid battery 1 includes the first adhesion layer 170 provided at least between the substrate 13 and the positive electrode 12 or between the substrate 13 and the negative electrode 11, and the second adhesion layer 171 provided at the peripheral edge 110a or peripheral edge 120a of at least one of the positive electrode 12 or the negative electrode 11 on which the first adhesion layer 170 is provided. The substrate 13 is formed from resin, the first adhesion layer 170 is formed from an adhesion sheet, and the second adhesion layer 171 is formed from an adhesive cured product.

The configuration (14) described above makes it possible to prevent the electrolyte from intruding from the outer peripheral side of the positive electrode 12 or the negative electrode 11 with the second adhesion layer 171, and to secure sufficient sulfuric acid resistance. Therefore, liquid junction between the positive electrode and the negative electrode caused by intrusion of sulfuric acid does not occur, and a battery having excellent long-term reliability can be constructed. The first adhesion layer 170 can prevent contamination in the portion where the positive electrode 12 and the negative electrode 11 are conducting.

(15) In the configuration (14) described above, the second adhesion layer 171 is further formed in the peripheral portion 110b and peripheral portion 120b on at least one of the substrate side or the side opposite to the substrate of at least one lead layer of the positive electrode 12 and/or the negative electrode 11 (positive electrode lead layer 120, negative electrode lead layer 110) on which the first adhesion layer 170 is provided.

The configuration (15) described above can prevent the electrolyte from intruding between the substrate 13 and the positive electrode 12 or the negative electrode 11 more than the configuration (14) described above, and therefore can further improve battery reliability. Note that in the present invention, the target bipolar battery is not limited to the bipolar lead acid battery 1, and other bipolar batteries can also be applied.

The bipolar battery according to one aspect of the present invention is a bipolar battery (for example, bipolar lead acid battery) including the bipolar electrode 10 including the positive electrode 12, the negative electrode 11, and the substrate 13 (also called a bipolar plate) having a first surface on which the positive electrode 12 is provided and a second surface on which the negative electrode 11 is provided. The bipolar battery includes the first adhesion layer 170 provided at least between the bipolar plate 13 and the positive electrode 12 or between the substrate 13 and the negative electrode 11, and the second adhesion layer 171 provided at the outer periphery of the first adhesion layer 170 of at least one of the positive electrode or the negative electrode on which the first adhesion layer 170 is provided. The substrate 13 is formed from resin, the first adhesion layer 170 is formed from an adhesion sheet, and the second adhesion layer 171 is formed from an adhesive cured product.

Furthermore, the second adhesion layer 171 may be formed at least one of between the substrate 13 and the positive electrode 12 or between the substrate 13 and the negative electrode 11. The second adhesion layer 171 may be provided at the peripheral edge of least one of the positive electrode 12 or the negative electrode 11 on which the first adhesion layer 170 is provided.

The following is a list of reference signs used in this specification and in the drawings.
1 bipolar lead acid battery
2 first plate unit
3 second plate unit
4 third plate unit
5 fourth plate unit
10 bipolar electrode
11 negative electrode
110 negative electrode lead layer
110a peripheral edge
110b peripheral portion
111 negative active material layer
12 positive electrode
120 positive electrode lead layer
120a peripheral edge
120b peripheral portion
121 positive active material layer
13 substrate (bipolar plate)
130 conduction hole
14 negative terminal
15 positive terminal
16 electrolytic layer
17 adhesion layer
170 first adhesion layer
171 second adhesion layer
172 hole
21 first plate (end plate)
31 second plate (spacer)
41 third plate (rim)
51 fourth plate (end plate)

What is claimed is:

1. A bipolar battery including a bipolar electrode including a positive electrode, a negative electrode, and a bipolar plate having a first surface on which the positive electrode is provided and a second surface on which the negative electrode is provided, the bipolar battery comprising:
a first adhesion layer provided at least between the bipolar plate and the positive electrode or between the bipolar plate and the negative electrode; and
a second adhesion layer provided at an outer periphery of the first adhesion layer of at least one of the positive electrode or the negative electrode on which the first adhesion layer is provided, wherein:
the bipolar plate is formed from resin,
the first adhesion layer is formed from an adhesion sheet, and
the second adhesion layer is formed from an adhesive cured product.

2. The bipolar battery according to claim 1, wherein the bipolar battery is a bipolar lead acid battery.

3. The bipolar battery according to claim 1, wherein the second adhesion layer is formed at least one of between the bipolar plate and the positive electrode or between the bipolar plate and the negative electrode.

4. The bipolar battery according to claim 3, wherein the bipolar battery is a bipolar lead acid battery.

5. The bipolar battery according to claim 3, wherein the second adhesion layer is formed with a width of 1.0 mm or more from a peripheral edge of at least one of the positive electrode or the negative electrode on which the first adhesion layer is provided.

6. The bipolar battery according to claim 5, wherein the bipolar battery is a bipolar lead acid battery.

7. The bipolar battery according to claim 5, wherein
the bipolar plate includes a plurality of conduction holes, and
the second adhesion layer is formed to a position 20 mm or more away from each of the conduction holes closest to the peripheral edge.

8. The bipolar battery according to claim 7, wherein the bipolar battery is a bipolar lead acid battery.

9. The bipolar battery according to claim 1, wherein the second adhesion layer is provided at a peripheral edge of at least one of the positive electrode or the negative electrode on which the first adhesion layer is provided.

10. The bipolar battery according to claim 9, wherein the bipolar battery is a bipolar lead acid battery.

11. The bipolar battery according to claim 9, wherein the second adhesion layer is further formed at a peripheral portion on at least one of a substrate side or a side opposite to the substrate of at least one of the positive electrode or the negative electrode on which the first adhesion layer is provided.

12. The bipolar battery according to claim 11, wherein the bipolar battery is a bipolar lead acid battery.
